(19) United States
(12) Patent Application Publication
(10) Pub. No.: US 2006/0215660 A1
(43) Pub. Date: Sep. 28, 2006

(54) Device and a method for generating routing messages for a GMPLS control plane communications network

(75) Inventors: Martin Vigoureux, Paris (FR); Emmanuel Dotaro, Verrieres Le Buisson (FR); Dimitri Papadimitriou, Brussels (BE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/372,141

(22) Filed: Mar. 10, 2006

(30) Foreign Application Priority Data
Mar. 11, 2005 (EP) 05300180.6

(51) Int. Cl. H04L 12/56

(52) U.S. Cl. 370/392

(57) ABSTRACT

A device (D) is dedicated to generating routing messages for a GMPLS control plane communications network. The device (D) includes processing means (MT) adapted to generate routing messages containing an attribute including each item of traffic engineering (TE) information data representing non-homogeneous characteristics of segments of at least one connection between network equipments (N) at the time of its declaration in its routing domain, the representation of that connection thereby defining a forwarding adjacency multiple access (FAMA) linear bus structure.

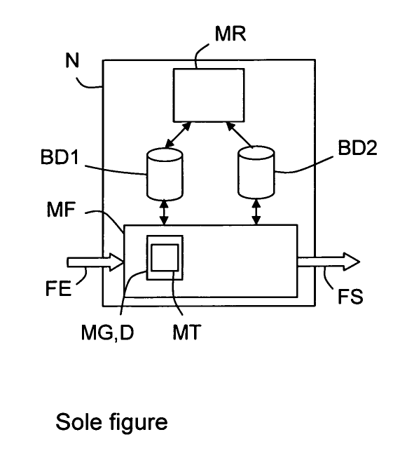

### BACKGROUND OF THE INVENTION

The invention relates to generalized multiprotocol label switching (GMPLS) control plane communications networks.

As the person skilled in the art is aware, in generalized multiprotocol label switching (GMPLS) control plane communications networks, label switched paths (LSP) can be defined between network equipments (or nodes).

An LSP is a connection set up in a network. Once it has been set up, the node that is at the head of the LSP has the option of converting it to a forwarding adjacency (FA) connection. In other words, the head node may decide to declare the LSP as if it were a traffic engineering link (TE link) between itself and the tail node at the opposite end of the connection. A routing protocol, for example of the OSPF-TE type, then handles the broadcasting of the information over this link to the other nodes of the network, which may use it to calculate their routes, in the same way that they use TE links that represent physical links. Consequently, an LSP is not systematically a forwarding adjacency (FA) connection.

Forwarding adjacency (FA) connections and TE links are generally associated with traffic engineering attributes such as the available bandwidth or the protection level. Since an FA represents a point-to-point forwarding adjacency connection between two nodes, the values of the traffic engineering attributes are unique, homogeneous and valid end-to-end, whatever the number of links (or segments) through which the underlying connection passes. However, it might happen that a connection has locally different characteristics in terms of traffic engineering attributes. For example, a connection might be protected over a segment in its middle but not at its ends. A connection might equally have different bandwidth utilization levels over one or more of its segments. Where they exist, capacities for adding and dropping traffic along a given connection might also be different from the line bit rate of the connection. For example, a forwarding adjacency connection that can support a single wavelength at 10 Gbit/s might be totally unused at a given time. It is therefore temporarily associated with an unreserved (or available) bandwidth of 10 Gbit/s. If all the nodes of this forwarding adjacency connection are capable of inserting 10 Gbit/s traffic, except for one of them, which can insert only 2.5 Gbit/s traffic, and if a node is using the information concerning the available forwarding adjacency bandwidth (10 Gbit/s) as a basis for deciding to route its 7 Gbit/s traffic to the node having a bit rate of 2.5 Gbit/s, then the traffic will be blocked at the level of the low bit rate node.

The mechanism for declaring an FA connection cannot take account of non-homogeneous (or variable) characteristics of the connection.

### SUMMARY OF THE INVENTION

An object of the invention is therefore to remedy the above-mentioned drawbacks in the context of a GMPLS control plane network.

To this end the invention proposes a method of generating routing messages for a GMPLS control plane communications network.

The method is characterized in that it consists in generating routing messages for representing at least some of the non-homogeneous or variable characteristics of one or more connections between network equipments (or nodes) at the time of their declaration in their routing domain. The structure resulting from this representation of a connection constitutes a linear bus which is referred to below as a forwarding adjacency multiple access (FAMA) linear bus.

According to the invention, each routing message that defines an FAMA structure includes an attribute including traffic engineering (TE) information data relating to each segment linking two network equipments participating in that FAMA structure and representing non-homogeneous characteristics of the segments.

For the nodes of the network, an FAMA structure is therefore a representation of a connection between a plurality of nodes at least some of which offer one or more entry and/or exit points at a time T. Like other FA connections, FAMA structures can be taken into account at the time of calculating routes (or paths) and therefore serve to route traffic across the network.

The information data representing non-homogeneous characteristics that can be transmitted includes at least some of the add/drop capacities of the interfaces that each network equipment participating in an FAMA structure includes, for example the access bit rate and/or the available bandwidth. As a general rule, any traffic engineering information useful for routing and concerning a segment between two network equipments (or nodes) participating in an FAMA structure or the network equipments (or nodes) of that segment can be transmitted. This information (relating to the traffic engineering attributes defined by the IETF) includes the bandwidth and/or the protection level of each segment of the FAMA structure, for example.

The information data representing non-homogeneous characteristics of a connection may be grouped into a multiplet, for example (e.g. a vector).

For example, information data representing non-homogeneous characteristics of each segment of an FAMA structure may be grouped into a multiplet and all information data common to all of the segments of an FAMA structure grouped into a singleton. For example, the information data of interfaces that offer non-homogeneous add/drop capacities may be grouped into a multiplet.

The invention also proposes a device for generating routing messages for a GMPLS control plane communications network.

The device is characterized in that it includes processing means adapted to generate routing messages containing an attribute including each item of traffic engineering information data representing non-homogeneous (or variable) characteristics of segments of at least one connection between network equipments (or nodes) at the time of its declaration in its routing domain, said representation of that connection thereby defining an FAMA structure.

For example, the processing means of the device may be responsible for placing in a routing message defining an FAMA structure information data representing non-homogeneous characteristics relating to at least some of the add/drop capacities of interfaces that each network equipment participating in that FAMA structure includes, for example the access bit rate and/or the available bandwidth. As a general rule, any traffic engineering information useful for routing and relating to a segment between two network equipments (or nodes) participating in an FAMA structure or the network equipments (or nodes) of that segment can be transmitted. This information (relating to the traffic engineering attributes defined by the IETF) includes, for example, the bandwidth and/or the protection level of each segment of the FAMA structure.

Moreover, the processing means of the device may group the information data of an FAMA structure representing non-homogeneous characteristics of the corresponding connection into a multiplet, for example (e.g. a vector).

For example, these processing means may group into a multiplet information data representing non-homogeneous characteristics of each segment of an FAMA structure and group into a singleton all information data common to all segments of an FAMA structure. For example, they may group information data of interfaces that offer non-homogeneous add/drop capacities.

Whether it is a question of the method or of the device, each routing message featuring an FAMA structure may be an instance of a message of a distributed routing protocol selected from at least the Open Shortest Path First-Traffic Engineering (OSPF-TE) protocol and the Intermediate System-Intermediate System-Traffic Engineering (IS-IS-TE) protocol.

The invention also proposes a network equipment, for example a router, equipped with a routing message generator of the type described hereinabove.

### BRIEF DESCRIPTION OF THE DRAWINGS

Other features and advantages of the invention will become apparent on reading the following detailed description and examining the appended drawing, the single figure of which is a functional block diagram of a router equipped-with one embodiment of a management device of the invention. The drawing constitutes part of the description of the invention and may, if necessary, contribute to the definition of the invention.

### DETAILED DESCRIPTION OF THE INVENTION

An object of the invention is to take account of at least some of the non-homogeneous (or variable) characteristics of the segments of an FAMA structure during calculation of traffic transmission routes in the context of a GMPLS control plane network.

The invention relates to any type of GMPLS control plane network.

Very broadly speaking, but nevertheless in sufficient detail for the invention to be understood, a GMPLS control plane network can be considered to include a multiplicity of network equipments that constitute nodes, that are connected to one another by links, and some of which might also be connected to corporate or local sub-networks of communications terminals (not shown), or in some cases to isolated terminals.

The network equipment (or node) type depends on its switching capacities. It may in particular be a label switched path (LSP) router.

The nodes of the network continuously exchange routing messages (or advertisements) in accordance with a distributed routing protocol, for example the Open Shortest Path First-Traffic Engineering (OSPF-TE) protocol or the Intermediate System-Intermediate System-Traffic Engineering (IS-IS-TE) protocol. These messages (or advertisements), known as Traffic Engineering-Link State Advertisements (TE-LSA), contain routing information representing certain characteristics of the links between nodes, for example the bandwidth used or available.

The routing information contained in these routing messages (or advertisements) enables the nodes to calculate the routes (or paths) used to route traffic.

Routes may be calculated using any algorithm known to the person skilled in the art.

As shown in the functional block diagram of the single figure, each node (or network equipment) N comprises:

a routing module MR (or a route calculation module);

a forwarding module MF coupled to its interface(s) (not shown);

first storage means BD1 that generally take the form of two routing databases, which may be separate, known as the routing information base and the forwarding information base; and

second storage means BD2 for storing routing information data contained in routing messages (or advertisements) received via the interfaces (arrow FE).

The routing information base stores routing data (or information) that the forwarding module MF needs to route received traffic to a subsequent router. The routing module MR determines (or calculates) this routing data from data contained in routing messages (or advertisements) and stored in the second storage means BD2.

The forwarding information base BD1 stores routing data (or information) enabling the forwarding module MF to route traffic to a subsequent router. This data essentially represents (re)transmission information extracted from the routing information base BD1.

The routing data (or information) stored in the storage means BD1 constitutes what is usually referred to as the routing tables of the node N, which are updated by the routing (or route calculation) module MR as a function of the routes that it determines.

Each node N also includes a routing message generator module MG for managing the transmission of routing messages intended for other nodes of the network via the output interfaces (arrow FS). Although the generator module MG is installed in the forwarding module MF in the example shown here, this is not obligatory.

The invention proposes to supply to the nodes of the GMPLS type control plane network routing messages representing at least some of the non-homogeneous (or variable) characteristics of one or more connections set up between the network equipments (or nodes) N at the time of their declaration in their routing domain.

This representation of a connection constitutes a bus-type linear structure that is referred to below as a forwarding adjacency multiple access (FAMA) structure. These FAMA structures are derived from forwarding adjacency (FA) structures that are well known to the person skilled in the art and detailed information on which may be found in particular on the website of the Internet Engineering Task Force (IETF).

For a node of the network, an FAMA structure is a representation of a connection between a plurality of nodes each of which offers one or more entry and/or exit points via its interface(s).

According to the invention, the routing messages are generated by a routing message generator D.

As shown here by way of non-limiting example, the routing message generator may be the routing message generator module MG that is installed in each node N. However, it could equally well be a portion of the module MG, a network element complementary to the module MG or a centralized network element operating on behalf of some or all of the nodes and coupled to their respective modules MG.

The routing message generator module D of the invention comprises a processing module MT for generating at least routing messages that represent at least some of the non-homogeneous (or variable) characteristics of the connections.

According to the invention, each routing message which defines an FAMA structure contains an attribute including traffic engineering (TE) information data relating to each segment linking two network equipments participating in that FAMA structure and representing non-homogeneous characteristics of the segments.

For example, the attribute containing the information data representing non-homogeneous characteristics of the segments of an FAMA structure may be a complementary attribute that the processing module MT appends to the standard attributes (or objects) of traffic engineering links (TE links) of a TE-LSA message (or advertisement).

The placing of the information data in a routing message featuring an FAMA structure obviously depends on the distributed routing protocol that is used to transmit it, which may in particular be the OSPF-TE protocol or the IS-IS-TE protocol. Moreover, each routing message featuring an FAMA structure may be an instance of a message of the routing protocol used.

The information data transmitted representing non-homogeneous characteristics of segments consists of at least some of the add/drop capacities of the interfaces that each network equipment N that participates in an FAMA structure includes, for example. The interface capacities that may be specified include in particular the access bit rate and the available bandwidth.

However, the information data transmitted representing non-homogeneous characteristics of segments may equally be the bandwidth and/or the protection level of each segment of the FAMA structure concerned. As a general rule, any traffic engineering information useful for routing and relating to a segment between two nodes N participating in an FAMA structure and the nodes N of that segment, and in particular their interfaces, may be integrated into a routing message.

What is more, the processing module MT may be adapted to group the information data of an FAMA structure representing non-homogeneous characteristics of the corresponding connection into a multiplet (or n-plet), for example. A multiplet may take the form of a vector, for example.

A multiplet can group information data of interfaces that offer non-homogeneous add/drop capacities, for example.

What is more, the processing module MT may group into a singleton all information data that is common to all segments of an FAMA structure, for example. Accordingly, groups of interface identifiers are constituted each associated with one or more common capacities, which reduces the amount of data of the attribute. However, a different approach could be adopted, for example specifying one or more capacities for each interface of each node.

Thanks to the information data contained in the routing messages that specifies the FAMA structures, the routing modules MR of the nodes N can calculate routes (or paths) that correspond not only to the state of the links between them but also to the state of each node and each segment of the network. Accordingly, outgoing traffic from a node can take the route that was calculated for this purpose.

The invention further offers new traffic engineering possibilities. In particular, it is now possible for a network operator to restrict access to certain resources of the network by imposing certain capacities at certain entry and/or exit points.

The routing message generator D of the invention, and in particular its processing module MT, may take the form of electronic circuits, software (or electronic data processing) modules or a combination of circuits and software.

The invention is not limited to the routing message generator and network equipment embodiments described above by way of example only and encompasses all variants that the person skilled in the art might envisage that fall within the scope of the following claims.

Accordingly, although there is described hereinabove one embodiment of a routing message generator installed in a node, and to be more precise constituting a module dedicated to generating all routing messages, if the device is not part of the dedicated module, it may simply supply to it routing messages that specify the FAMA structures.

1. A method of generating routing messages for a GMPLS control plane communications network, characterized in that it consists in generating routing messages each containing an attribute including traffic engineering (TE) information data representing non-homogeneous characteristics of segments of one or more connections between network equipments (N) at the time of its declaration in its routing domain, said representation of that connection thus defining a forwarding adjacency multiple access (FAMA) linear bus structure.

2. A method according to claim 1, characterized in that at least some of said information data representing non-homogeneous characteristics of segments of said connection relates to at least some of the add/drop capacities of interfaces that each network equipment (N) participating in an FAMA structure includes.

3. A method according to claim 1, characterized in that at least some of said information data representing non-homogeneous characteristics of segments of said connection relates to traffic engineering information useful for routing and relating to a segment between two network equipments (N) participating in an FAMA structure or the network equipments (N) of said segment.

4. A method according to claim 1, characterized in that said information data representing non-homogeneous characteristics of segments of said connection within a multiplex is grouped together.

5. A method according to claim 2, characterized in that said add/drop capacities of the interfaces are selected from a group including the access bit rate and the available bandwidth.

6. A method according to claim 1, characterized in that each routing message featuring an FAMA structure is an instance of a message of a distributed routing protocol selected from a group including the OSPF-TE and IS-IS-TE protocols.

7. A device (D) for generating routing messages for a GMPLS control plane communications network, characterized in that it includes processing means (MT) adapted to generate routing messages containing an attribute including each item of traffic engineering (TE) information data representing non-homogeneous characteristics of segments of at least one connection between network equipments (N) at the time of its declaration in its routing domain, said representation of that connection thereby defining a forwarding adjacency multiple access (FAMA) linear bus structure.

8. A device according to claim 7, characterized in that at least some of said information data representing non-homogeneous characteristics of the segments of said connection relates to at least some of the add/drop capacities of interfaces that each network equipment (N) participating in the corresponding FAMA structure includes.

9. A device according to claim 7, characterized in that at least some of said information data representing non-homogeneous characteristics of the segments of said connection relates to traffic engineering information useful for routing and relating to a segment between two network equipments (N) participating in an FAMA structure or the network equipments (N) of said segment.

10. A device according to claim 7, characterized in that said processing means (MT) are adapted to group said information data representing non-homogeneous characteristics of the segments of said connection into a multiplet.

11. A device according to claim 8, characterized in that said add/drop capacities of the interfaces are selected from a group including the access bit rate and the available bandwidth.

12. A device according to claim 7, characterized in that said processing means (MT) are adapted to generate routing messages featuring FAMA structures in the form of instances of messages of a distributed routing protocol selected from a group including the OSPF-TE and IS-IS-TE protocols.

13. A network equipment (N) for a GMPLS control plane communications network, characterized in that it comprises a routing message generator (D) according to claim 7.
